(19) United States
(12) Patent Application Publication
(10) Pub. No.: US 2013/0277366 A1
(43) Pub. Date: Oct. 24, 2013

(54) CAT NEEDS ORGANIZER

(71) Applicant: Sara Paculdo, San Francisco, CA (US)

(72) Inventor: Sara Paculdo, San Francisco, CA (US)

(73) Assignee: Worldwise, Inc., San Rafael, CA (US)

(21) Appl. No.: 13/450,100

(22) Filed: Apr. 18, 2012

(51) Int. Cl. B65D 21/028; B65F 1/00; B65D 25/04

(52) U.S. Cl. 220/23.4; 220/500

(57) ABSTRACT

A cat needs organizer in the form of a shell, said shell having a base for residing upon a horizontal surface and sidewalls emanating therefrom creating an interior space. The interior space is subdivided by partitions creating subspaces sized to receive cat needs products and at least one sidewall configured to removably receive an ancillary receptacle, such as a disposal container for litter, or other receptacle related to the cat needs.

### TECHNICAL FIELD

The present invention involves an organizer for receiving and maintaining products related to cat needs.

### BACKGROUND OF THE INVENTION

Oftentimes, domestic cats are kept in apartments and small surroundings where space can be a premium. Yet, there are a number of products required to meet the needs of a pet cat, these products being left either strewn about the living space or stuffed in drawers where ready access is not always at hand.

Cat owners routinely use litter, litter scoops, litter disposal container liners, odor absorbing powders, dustpans and brushes as cat needs products. Such products should ideally be maintained proximate the cat's litter box which contains litter, necessary for maintaining the hygiene of the pet. Litter is routinely cleaned of waste debris using a litter scoop and such debris placed within a disposal container, usually lined and maintained proximate to the scoop and litter box. A litter box and other ancillary cat needs products should, in an ideal situation, be positioned near each other and to a disposal container and organizer to enable the box to be properly maintained. In addition, the organizer should have one or more removable receptacles which can be moved from the interior of the organizer to an outside surface to make its contents more accessible to the pet owner. For example, it may prove helpful to place litter box liners in an external, readily accessible location to eliminate the need of the pet owner to fumble about the organizer when preoccupied during litter cleanup and replacement.

It is thus an object of the present invention to provide an organizer for cat needs products to avoid needless clutter and to maintain such products proximate the cat's litter box and litter disposal container.

This object will be more readily appreciated when considering the following disclosure and appended claims.

### SUMMARY OF THE INVENTION

A cat needs organizer in the form of a shell, said shell having a base for residing upon a horizontal surface and sidewalls emanating therefrom creating an interior space. The interior space is subdivided by partitions creating subspaces sized to receive cat needs products and at least one sidewall configured to removably receive an ancillary receptacle, such as a disposal container for litter, or other receptacle related to the cat needs.

### BRIEF DESCRIPTION OF THE FIGURES

FIG. 1 is a perspective view of the cat needs organizer of the present invention in a first orientation.

FIG. 2 is a perspective view of the cat needs organizer of FIG. 1 in a second orientation and including a litter disposal container appended thereto.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

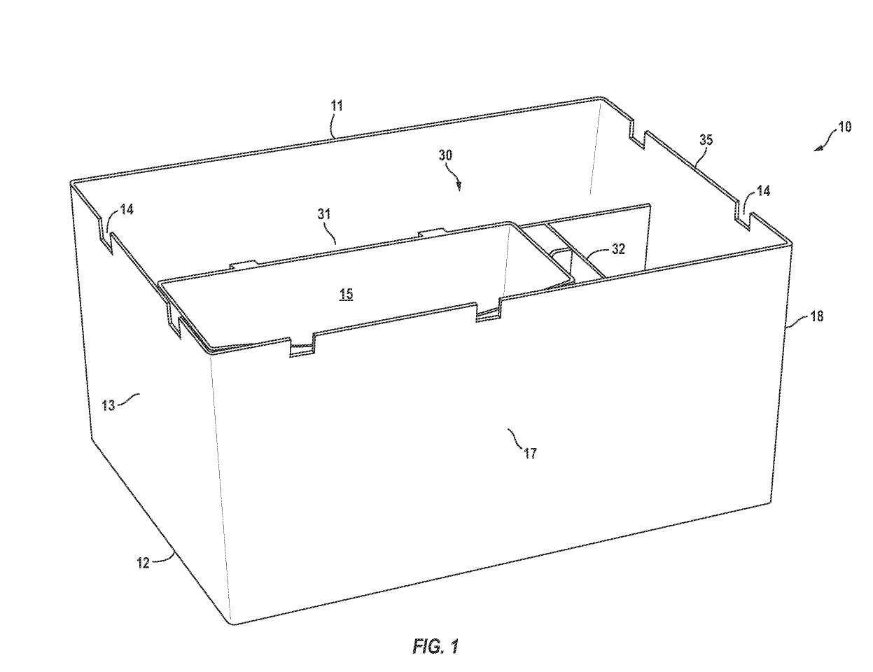

Turning to FIG. 1, cat needs organizer 10 is shown comprising a shell composed of sidewalls 11, 13, 17 and 18 and base 12 for residing upon a horizontal surface. Sidewalls 11, 13, 17 and 18 emanate from base 12 creating interior space 30. Interior space 30 is subdivided by partitions 31, 32 etc. creating subspaces sized to receive cat needs products of the type described previously. All of these anticipated cat needs products are those which are routinely used by the pet owner to maintain either the pet cat, the cat's litter box or its surrounding area.

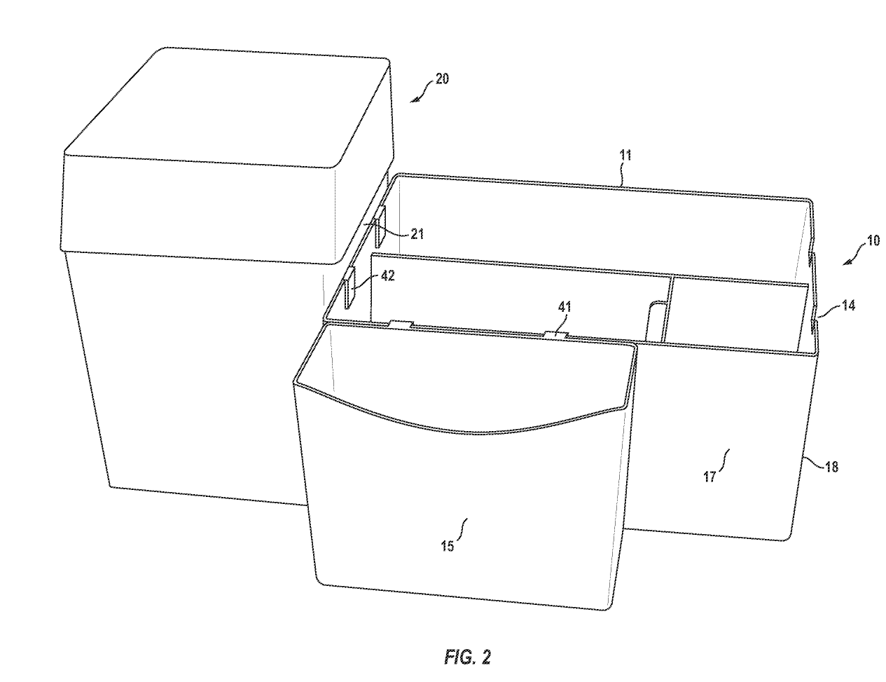

In comparing FIGS. 1 and 2, it is noted that receptacle 15 can nest within space 16 to be made part of inner volume 30 of organizer 10. However, when a product needing ready access is contained within receptacle 15, it can be removed from subspace 16 and placed at the exterior of organizer 10. The present invention is specifically configured to facilitate this reorientation of parts.

Cat needs organizer 10 is provided with at least one sidewall, in this instance, shown as sidewalls 13 and 18 configured with at least one notch 14 within top edge 35 shown on sidewall 18. Notches 14 are created to enable organizer 10 to receive ancillary receptacles. In this regard, reference is made to FIG. 2.

As illustrated, when removable receptacle 15 is taken from subspace 16, it is moved flush against sidewall 17 and protrusions 41 caused to be received by notches similar to notches 14 shown in sidewall 18. This allows removable receptacle 15 to nest within inner volume 30 or to hang from its outer surface depending upon the needs of a user. Similarly, an ancillary object such as litter disposal container 20 including protrusions 42 can selectively append to organizer 10 as shown. As such, when placing organizer 10 proximate a cat's litter box, servicing the litter box can be made conveniently by positioning litter disposal container 20 as shown being selectively appended to organizer 10 to ensure that spent litter and animal waste can be conveniently disposed of in the immediate vicinity of the litter box. Thus, the present invention provides an organizer uniquely suited to house and maintain a number of diverse items which are commonly employed on a routine basis by pet owners needed for the routine maintenance of a family pet and its surrounding environment.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1-5. (canceled)

6. A cat needs organizer comprising a shell, said shell having a base for residing upon a horizontal surface and organizer sidewalls emanating therefrom creating an interior space with an open top, said organizer sidewalls having top edges, a plurality of which are provided with at least one notch, at least one receptacle sized for residing within said interior space and having receptacle sidewalls having at least one protrusion sized and positioned to be received by said at least one notch, said receptacle being sized and configured to be removable from said interior space and to hang from said at least one of said organizer sidewalls exterior to said interior space by joining said at least one protrusion with said at least one of said notches and further comprising a lidded litter disposable container.

7. The cat needs organizer of claim 6 further comprising partitions for creating subspaces within said interior space, said receptacle being sized to fit within one of said subspaces.
